(19) United States
(12) Patent Application Publication
(10) Pub. No.: US 2016/0215799 A1
(43) Pub. Date: Jul. 28, 2016

(54) MAGNETIC ATTACHMENT

(71) Applicant: APPLE, INC., Cupertino, CA (US)

(72) Inventors: Colin M. Ely, Cupertino, CA (US); Erik G. de Jong, Cupertino, CA (US); Fletcher R. Rothkopf, Cupertino, CA (US)

(21) Appl. No.: 15/023,852

(22) PCT Filed: Sep. 29, 2013
(86) PCT No.: PCT/US2013/062512

§ 371 Date: Mar. 22, 2016

(51) Int. Cl. F16B 1/00; A44C 5/14; H01F 7/02

(52) U.S. Cl. CPC F16B 1/00; H01F 7/0205; A44C 5/147; F16B 2001/0035

(57) ABSTRACT

A first attachment structure of a first attachment element includes apertures and first attachment structure magnetic elements. A second magnetic structure of a second attachable element includes inner and outer magnetic elements. The second attachment structure is moveable between a first and a second position. Movement between the positions may rotate the inner and outer magnetic elements. In the first position, the first attachment structure magnetic element may not attract the outer magnetic element and magnetic force from the inner magnetic element may pull the outer magnetic element toward the inner magnetic element and out of the aperture. In the second position, the first magnetic structure magnetic element may exert magnetic force on the outer magnetic element to overcome the magnetic bond between the inner magnetic element and the outer magnetic element and pull the outer magnetic element toward the first magnetic structure magnetic element and into the aperture.

### TECHNICAL FIELD

This disclosure relates generally to attachment mechanisms, and more specifically to magnetic attachment mechanisms.

### BACKGROUND

Many devices are attachable to other items via various attachment mechanisms. For example, a tablet computing device may be attachable to an external keyboard in order for the keyboard to be utilized with the tablet computing device. By way of another example, a wearable device such as a watch may be attachable to a band that enables the watch to be coupled to a user's wrist.

Often, mechanical attachment systems are utilized to attach attachable devices. However, though often providing great attachment strength as well as flexibility and durability, many mechanical attachment systems are complex and burdensome for users to operate. For example, an external keyboard may be attachable to a tablet computing device utilizing a compressible pin system. To attach the external keyboard to the tablet computing device, a user may need to compress a pin element of the external keyboard such that the pin element fits within apertures of the tablet computing device, whereupon the pin element decompresses in order to extend through the apertures and mechanically attach the external keyboard to the tablet computing device. In order to detach the external keyboard from the tablet computing device, a user may need to again compress the pin element to withdraw the pin element from the apertures so that the external keyboard is no longer mechanically attached to the tablet computing device and can be removed.

In order to enable less complex and/or burdensome attachment/detachment, magnetic attachment systems may be utilized to attach attachable devices. For example, an external keyboard may include magnets that have polarities opposed to magnets of a tablet computing device. To attach the external keyboards, a user may merely have to contact the magnets of the external keyboard to the magnets of the tablet computing device. In order to detach the external keyboard from the tablet computing device, a user may simply have to pull on the devices hard enough to overcome the magnetic attraction of the magnets. However, though such magnetic attachment mechanisms are relatively simple and not burdensome to operate, they may not provide great attachment strength, flexibility, or durability.

### SUMMARY

The present disclosure discloses systems and methods for magnetic attachment. A first attachment structure of a first attachment element includes apertures and first attachment structure magnetic elements. A second magnetic structure of a second attachable element includes inner and outer magnetic elements. The second attachment structure is moveable between a first and a second position. Movement between the positions may rotate the inner and outer magnetic elements. In the first position, the first attachment structure magnetic element may not attract the outer magnetic element and magnetic force from the inner magnetic element may pull the outer magnetic element toward the inner magnetic element and out of the aperture. In the second position, the first magnetic structure magnetic element may exert magnetic force on the outer magnetic element to overcome the magnetic bond between the inner magnetic element and the outer magnetic element and pull the outer magnetic element toward the first magnetic structure magnetic element and into the aperture.

In some implementations, the first attachment structure magnetic elements, the inner magnetic elements, and or the outer magnetic elements may each comprise one or more hard magnets. In other implementations, the first attachment structure magnetic elements, the inner magnetic elements, and or the outer magnetic elements may each comprise one or more soft magnets.

In various cases, the polarities of the first attachment structure magnetic elements may only not oppose the polarities of the outer magnets in the second position. However, in other implementations, the polarities of the first attachment structure magnetic elements may match the polarities of the outer magnets in the second position. In such implementations, the first attachment structure magnetic elements may repulse or repel the outer magnets in the second position. In some cases, the polarities of the inner magnetic elements may oppose the polarities of the outer magnetic elements in both the first and second positions.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1A is a isometric view of magnetic attachment system illustrating a second attachment structure of the magnetic system in an assembled position.

FIG. 1B illustrates the magnetic attachment system of FIG. 1A after the second attachment structure has been moved to a disassemble position.

FIG. 1C is a front cross sectional view of the magnetic attachment system of FIG. 1A taken along line 1C of FIG. 1A.

FIG. 1D is a front cross sectional view of the magnetic attachment system of FIG. 1A taken along line 1D of FIG. 1B.

FIG. 1E is a isometric view of magnetic attachment system of FIG. 1A wherewith everything removed but the housing magnetic elements, the outer magnetic elements, and the inner magnetic elements.

FIG. 1F is a isometric view of magnetic attachment system of FIG. 1B wherewith everything removed but the first attachment structure magnetic elements, the outer magnetic elements, and the inner magnetic elements.

FIG. 2 is a cross sectional view of an alternative embodiment of the magnetic attachment system illustrated in FIG. 1D.

FIG. 3 is a method diagram illustrating a method for attaching a first attachable element to a second attachable element. This method may be performed by the system of FIGS. 1A-1F or 2.

FIG. 4 is a method diagram illustrating a method for detaching a first attachable element from a second attachable element. This method may be performed by the system of FIGS. 1A-1F or 2.

### DETAILED DESCRIPTION

The description that follows includes sample systems, methods, and computer program products that embody various elements of the present disclosure. However, it should be understood that the described disclosure may be practiced in a variety of forms in addition to those described herein.

The present disclosure discloses systems and methods for magnetic attachment. A first attachment structure of a first attachment element may include at least one aperture and at least one first attachment structure magnetic element. A second magnetic structure of a second attachable element may include at least one inner magnetic element and at least one outer magnetic element. The second attachment structure may be moveable between a first and a second position.

Movement between the first and second positions may rotate the inner magnetic element and the outer magnetic element. In the first position, the first attachment structure magnetic element may not attract the outer magnetic element and magnetic force from the inner magnetic element may pull the outer magnetic element toward the inner magnetic element and out of the aperture. In the second position, the first magnetic structure magnetic element may exert magnetic force on the outer magnetic element to overcome the magnetic bond between the inner magnetic element and the outer magnetic element and pull the outer magnetic element toward the first magnetic structure magnetic element and into the aperture.

In this way, the first attachment element may not be mechanically and magnetically attached to the second attachment element in the first position, but may be in the second position.

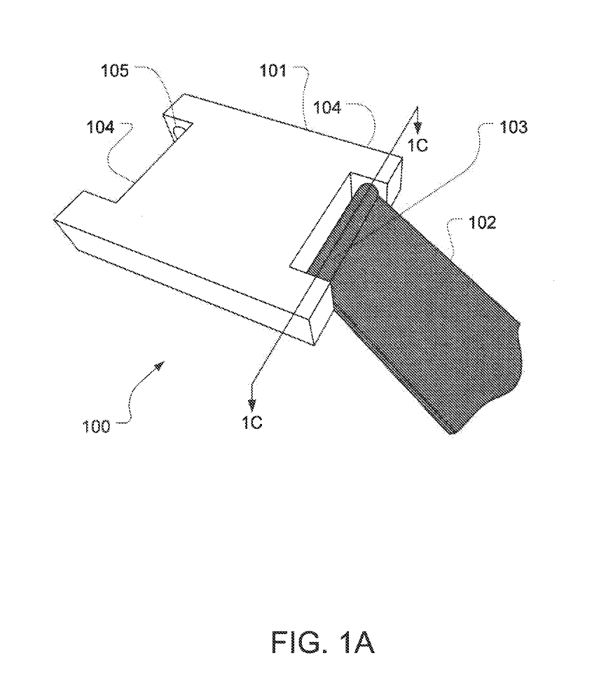

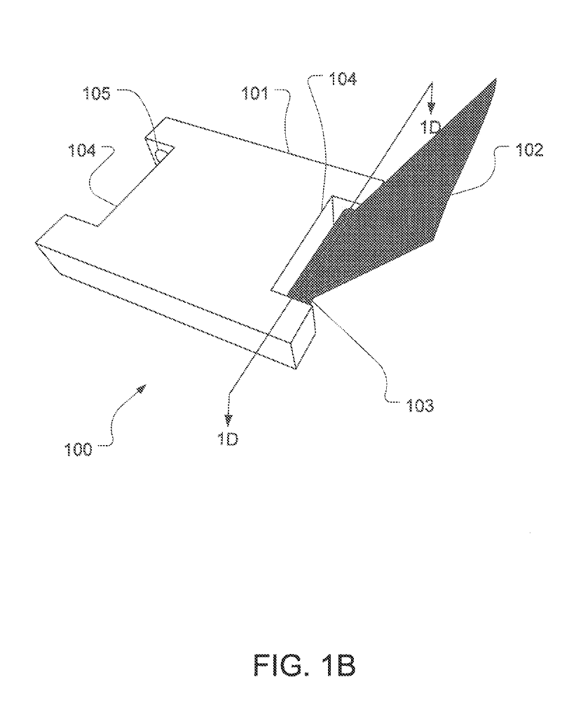

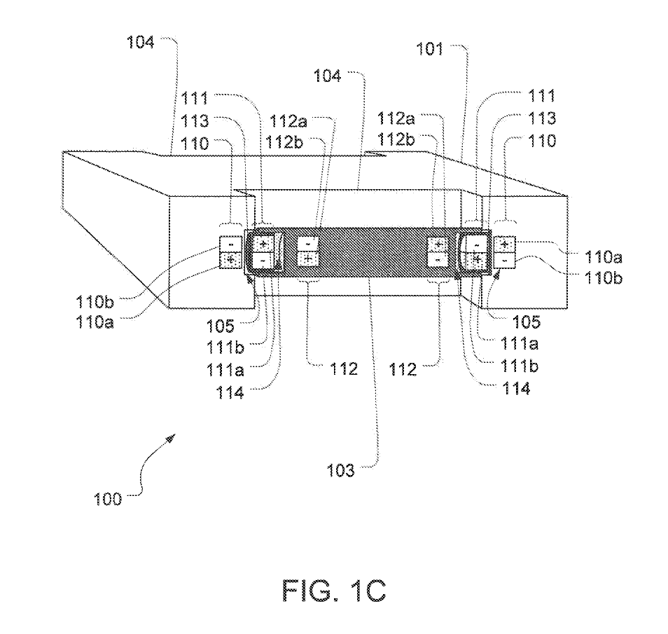

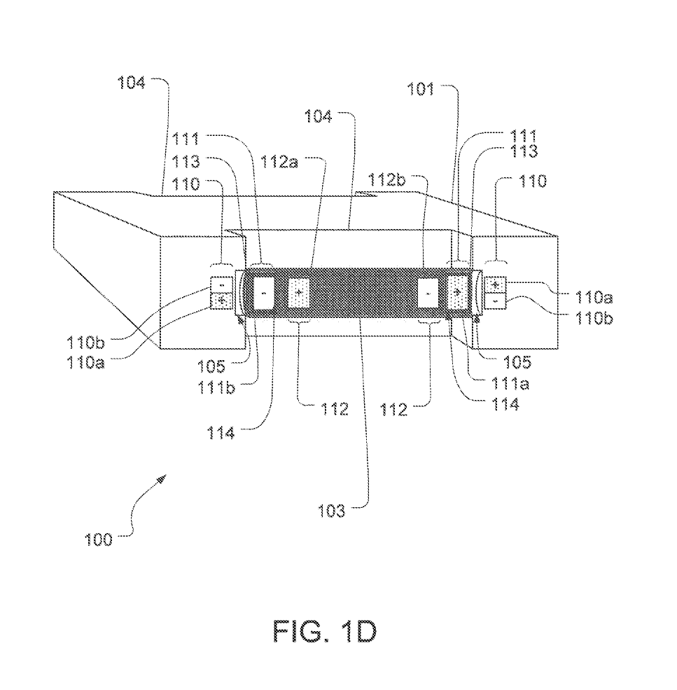

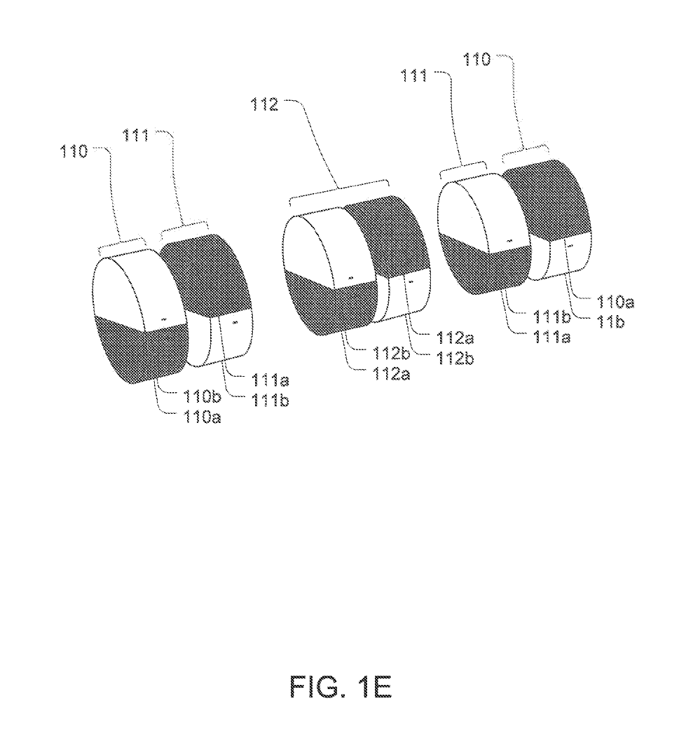

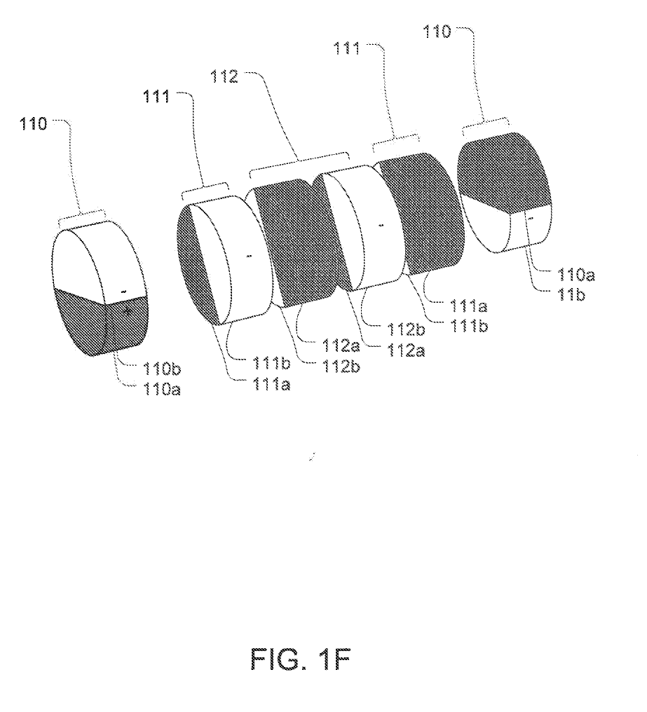

FIG. 1A is a isometric view of magnetic attachment system 100. As illustrated, a first attachment structure 104 of a first attachable element 101 is shown attached to a second attachment structure 103 of a second attachable element 102. As can be seen in the other attachment structure of the first attachable element to which the second attachment structure of the second attachable element is not attached, the first attachment structure of the first attachable element may include first attachment structure apertures 105 on opposing internal surfaces.

Though the first attachable element 101 is shown as a housing for a device and the second attachable element 102 is shown as a band, it is understood that this is an example. In various implementations the first and second attachable elements may be any kind of elements that may be attached.

Further, although the second attachable element 102 is shown as having a single second attachment structure 103, it is understood that this is an example. In various implementations, the second attachable element may include another attachment structure on the other end of the band which may be attached to the other attachment structure of the first attachable element 101 to which nothing is shown as attached. Such an implementation may enable the first attachable element to be worn by a user by coupling the band around a body part (such as a wrist) of the user. Additionally, such a band may include multiple band sections that are attachable utilizing multiple attachment structures. Such additional attachment structures may enable such functions as sizing of the band.

In FIG. 1A, the second attachment structure 103 of the second attachable element 102 is in a first position. This first position may be an “assembled” position. In the assembled position, the second attachment structure may be magnetically and mechanically attached to the first attachment structure 104. Via the attachment of the second attachment structure to the first attachment structure, the second attachable element may be magnetically and mechanically attached to the first attachable element 101.

FIG. 1B illustrates the magnetic attachment system 100 of FIG. 1A after the second attachment structure 103 has been moved to a second, “disassemble” position. In the disassemble position, the second attachment structure may not be magnetically and mechanically attached to the first attachment structure 104. As the second attachment structure is no longer magnetically and mechanically attached to the first attachment structure, the second attachment structure may be removed from the first attachment structure in the disassemble position. Hence, in the disassemble position, the second attachable element 102 may be detached from the first attachable element 101.

FIG. 1C is a front cross sectional view of the magnetic attachment system 100 taken along line 1C of FIG. 1A. As illustrated, the first attachment structure 104 includes first attachment structure magnetic elements 110 (or housing magnetic elements) positioned proximate to first attachment structure apertures 105. The first attachment structure magnetic elements each may include positively polarized areas 110a and negatively polarized areas 110b.

As also illustrated, the second attachment structure 103 includes inner magnetic elements 112, outer magnetic elements 111, and second attachment structure apertures 114. The outer magnetic elements each may include positively polarized areas 121a and negatively polarized areas 112b. Similarly, the outer magnetic elements each may include positively polarized areas 111a and negatively polarized areas 111b.

As shown, the body of the second attachment structure 103 may act as a spacer material to separate the inner magnetic elements 112 and/or separate the inner magnetic elements from the outer magnetic elements 111. Additionally the body of the second attachment structure may define the second attachment structure apertures 114. In order to protect the inner magnetic elements and/or outer magnetic elements during movement of the outer magnetic elements, the body may be formed from one or more compliant materials such as plastic, elastomer, and/or any other material that protects the inner magnetic elements and/or outer magnetic elements during movement of the outer magnetic elements.

Further as shown, the second attachment structure 103 may also include pin elements 113. The outer magnetic elements 111 may be components of the pin elements. Such pin elements may be formed of (in addition to the outer magnetic elements) steel, elastomer, plastic, and/or any other such suitable material.

As illustrated, in the assembled position the polarities of the outer magnetic elements 111 may oppose the polarities of the first attachment structure magnetic elements 110. As such, the first attachment structure magnetic elements may exert a magnetic force upon the outer magnetic elements in the assembled position. Similarly, the polarities of the outer magnetic elements may oppose the polarities of the inner magnetic elements 112 and, as such, the inner magnetic elements may also exert a magnetic force upon the outer magnetic elements.

However, in the assembled position the first attachment structure magnetic elements 110 may exert sufficient magnetic force upon the outer magnetic elements 111 such that the magnetic force between the inner magnetic elements 112 and the outer magnetic elements is overcome. As such (and as shown) the outer magnetic elements are pulled by the magnetic force exerted by the first attachment structure magnetic elements into the first attachment structure apertures 105. This may result in the first attachment structure 101 being magnetically attached to the second attachment structure 102 in the assembled position.

Further, as the pin elements 113 and/or the outer magnetic elements 111 are partially positioned in the first attachment structure apertures 105 and the second attachment structure apertures 114 in the assembled position, the pin elements and/or outer magnetic elements form a mechanical attachment. As such, the first attachment structure 101 may be mechanically attached to the second attachment structure 102 in the assembled position.

FIG. 1D is a front cross sectional view of the magnetic attachment system 100 of taken along line 1D of FIG. 1B. As illustrated, when the second attachment structure 102 is moved from the assembled to the disassemble position, the inner magnetic elements 112 and the outer magnetic elements 111 may rotate. However, the first attachment structure magnetic elements 110 may not rotate when the second attachment structure is moved from the assembled to the disassemble position.

As such, in the disassembled position, the polarities of the outer magnetic elements 111 may no longer oppose the polarities of the first attachment structure magnetic elements 110. Thus, the first attachment structure magnetic elements may no longer exert the magnetic force upon the outer magnetic elements in the disassemble position. However, the polarities of the outer magnetic elements may still oppose the polarities of the inner magnetic elements 112 and, as such, the inner magnetic elements may still exert the magnetic force upon the outer magnetic elements.

Therefore, in the disassemble position, the magnetic force between the inner magnetic elements 112 and the outer magnetic elements 111 may pull the outer magnetic elements out of the first attachment structure apertures 105 and into the second attachment structure apertures 114. This may result in the first attachment structure 101 no longer being magnetically attached to the second attachment structure 102 in the disassemble position. Further, as the pin elements 113 and/or the outer magnetic elements are no longer partially positioned in the first attachment structure apertures 105, the first attachment structure may be no longer be mechanically attached to the second attachment structure 102 in the disassemble position.

The polarities of the first attachment structure magnetic elements 110 no longer oppose the polarities of the outer magnetic elements 111 in the disassemble position because the polarized areas 110a and 110b of the first attachment structure magnetic elements are offset 90 degrees from the polarized areas 111a and areas 111b of the outer magnetic elements. This is contrasted with the assembled position illustrated in FIG. 1C where the polarized areas of the first attachment structure magnetic elements are offset 180 degrees from the polarized areas of the outer magnetic elements.

However, it is understood that this is an example and in various cases the polarized areas 110a and 110b of the first attachment structure magnetic elements 110 may be offset from the polarized areas 111a and areas 111b of the outer magnetic elements 111 differently than 180 degrees in the assembled position and 90 degrees in the disassemble position. For example, in various implementations the polarized areas of the first attachment structure magnetic elements may not be offset from the polarized areas of the outer magnetic elements (i.e., matching polarities) in the disassemble position. This may cause the first attachment structure magnetic elements to repel or repulse the outer magnetic elements in the disassemble position.

FIG. 1E is a isometric view of magnetic attachment system of FIG. 1A wherewith everything removed for the purposes of clarity but the first attachment structure magnetic elements 110, the outer magnetic elements 111, and the inner magnetic elements 112. By way of contrast, FIG. 1F is a isometric view of magnetic attachment system of FIG. 1B wherewith everything removed for the purposes of clarity but the first attachment structure magnetic elements, the outer magnetic elements, and the inner magnetic elements. From FIGS. 1E and 1F, the relative rotations and the relative positions of the positive and negative polarized areas of the first attachment structure magnetic elements, the outer magnetic elements, and the inner magnetic elements in the assembled (FIG. 1E) and disassemble positions (FIG. 1F) can be easily seen.

Returning to FIG. 1C, in various implementations, the first attachment structure magnetic elements 110, the outer magnetic elements 111, and/or the inner magnetic elements 112 may each be one or more hard magnets (i.e., materials that are permanently magnetic) and/or one or more soft magnets (i.e., materials such as ferrous metals that can be magnetized but do not stay permanently magnetized).

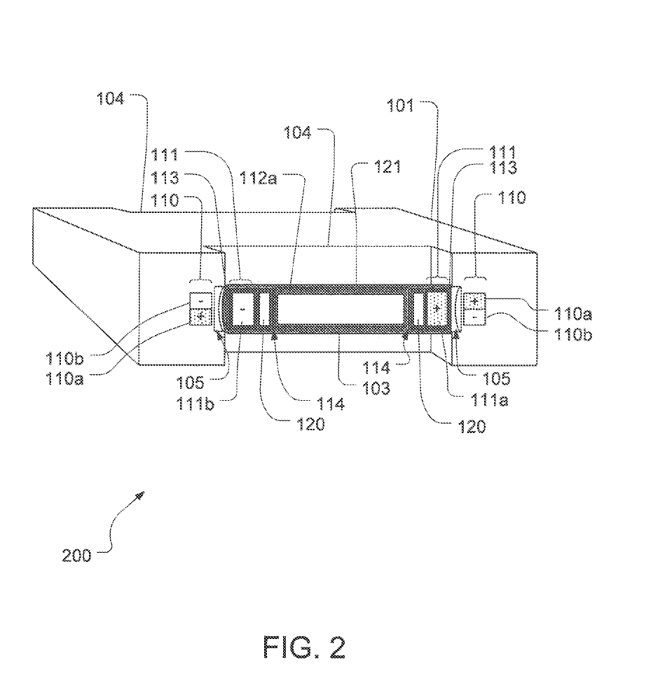

FIG. 2 is a cross sectional view of an alternative embodiment 200 of the magnetic attachment system illustrated in FIG. 1D. To contrast the mechanical attachment system 100 of FIG. 1C, the mechanical attachment system 200 of FIG. 1D may include a soft magnetic element 121 (which may be a steel or other ferrous metal core) instead of inner magnetic elements 112. Further, the mechanical attachment system 200 may include spacer elements 120 that separate the outer magnetic elements 111 from the soft magnetic element. Such spacer elements may protect the outer magnetic elements and/or the soft magnetic element during movement of the outer magnetic elements. Further, such spacer elements may be formed from one or more compliant materials such as plastic, elastomer, and/or any other material that protects the outer magnetic elements and/or the soft magnetic element during movement of the outer magnetic elements.

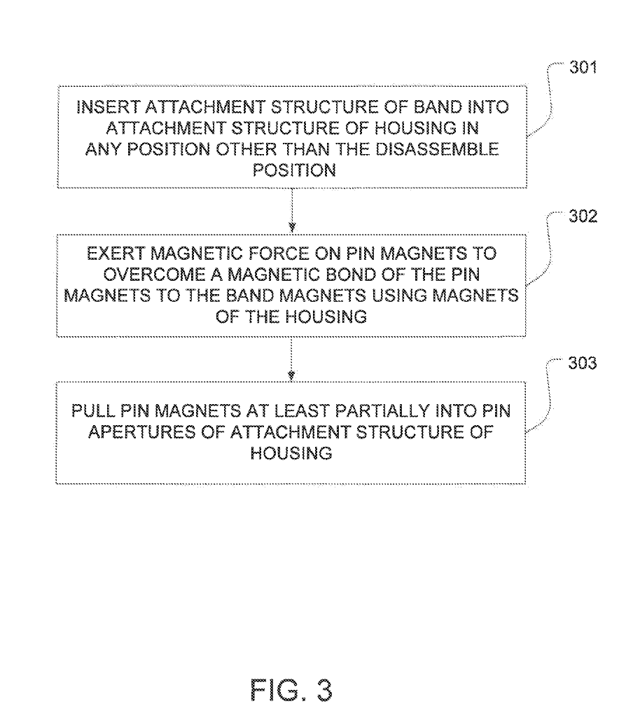

FIG. 3 is a method diagram illustrating a method 300 for attaching a first attachable element to a second attachable element. This method may be performed by the system of FIGS. 1A-1F or 2.

The flow may begin at block 301 where a first attachment structure of a first attachable element such as a band is inserted into a second attachment structure of a second attachable element such as a housing. The insertion may be performed such that the first attachment structure is in any position other than a disassemble position (such as an assembled position) upon insertion.

Next, the flow may proceed to block 302 where a magnetic force is exerted on the pin magnets to overcome a magnetic bond of the pin magnets to the band magnets using magnets of the housing. Finally, the flow may proceed to block 304 where the pin magnets are pulled at least partially into pin apertures of the attachment structure of the housing. Upon completion of block 304, the attachment structures of the housing and band, as well as the housing and band themselves, may be mechanically and magnetically attached.

Although the method 300 is illustrated as including particular operations performed in a particular order, it is understood that this is an example. In various implementations, different orders of the same, similar, and/or different operations may be performed without departing from the present disclosure. For example, the method 300 illustrates blocks 302-304 as performed in a linear sequence. However, in various implementations such operations may be performed simultaneously.

By way of another example, the method 300 describes inserting the attachment structure of the band in any position other than a disassemble position. However, in some implementations, insertion of the attachment structure of the band in a position other than the disassemble position may include inserting the attachment structure in the disassemble position and manipulating the attachment structure to a position other than the disassemble position.

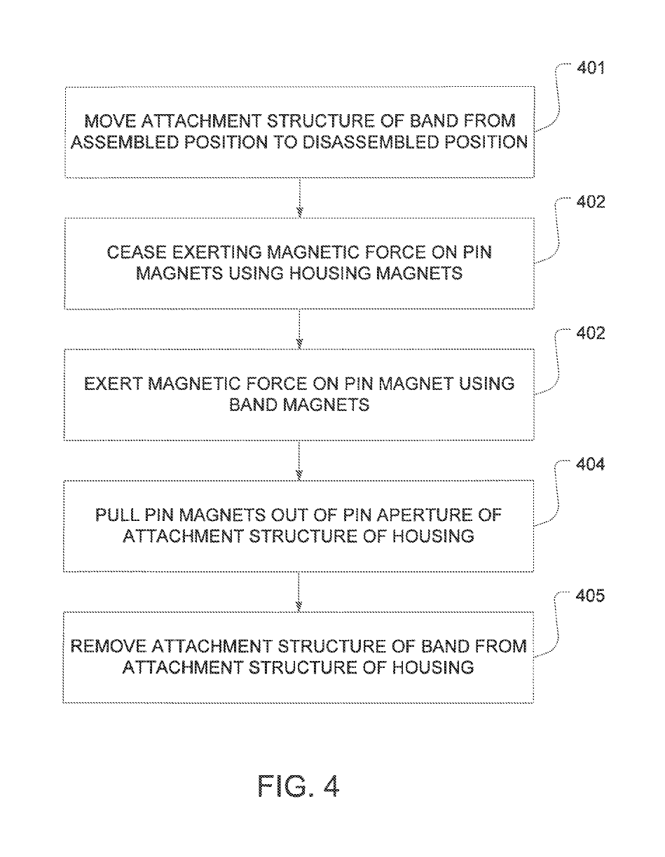

FIG. 4 is a method diagram illustrating a method for detaching a first attachable element from a second attachable element. This method may be performed by the system of FIGS. 1A-1F or 2.

The flow may begin at block 401 where a first attachment structure of a first attachable element such as a band is moved from a first, or assembled, position to a second, or disassembled, position.

Next, the flow may proceed to block 402 where a magnetic force is ceased to be exerted on pin magnets by magnets of a second attachment structure of a second attachable element, such as a housing. The flow then proceeds to block 403 where magnets of the band exert magnetic force on the pin magnets. Then, the flow proceeds to block 404 where the pin magnets are pulled out of pin apertures of the attachment structure of the housing. Upon completion of block 404, the attachment structures of the housing and band, as well as the housing and band themselves, may be mechanically and magnetically attached.

Finally, the flow may proceed to block 405 where the attachment structure of the band may be removed from the attachment structure of the housing.

Although the method 400 is illustrated as including particular operations performed in a particular order, it is understood that this is an example. In various implementations, different orders of the same, similar, and/or different operations may be performed without departing from the present disclosure. For example, the method 400 illustrates blocks 401-404 as performed in a linear sequence. However, in various implementations such operations may be performed simultaneously.

As described above and illustrated in the accompanying figures, the present disclosure discloses systems and methods for magnetic attachment. A first attachment structure of a first attachment element may include at least one aperture and at least one first attachment structure magnetic element. A second magnetic structure of a second attachable element may include at least one inner magnetic element and at least one outer magnetic element. The second attachment structure may be moveable between a first and a second position. Movement between the first and second positions may rotate the inner magnetic element and the outer magnetic element. In the first position, the first attachment structure magnetic element may not attract the outer magnetic element and magnetic force from the inner magnetic element may pull the outer magnetic element toward the inner magnetic element and out of the aperture. In the second position, the first magnetic structure magnetic element may exert magnetic force on the outer magnetic element to overcome the magnetic bond between the inner magnetic element and the outer magnetic element and pull the outer magnetic element toward the first magnetic structure magnetic element and into the aperture.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. An electronic device, comprising:
a first attachment structure of an electronic device housing, comprising:
an aperture; and
a magnetic element; and
a second attachment structure of a band that is operable to attach the electronic device housing to a user, comprising:
an inner magnetic element; and
an outer magnetic element;
wherein:
the second attachment structure is moveable between a first position and a second position when inserted into the first attachment structure;
moving the second attachment structure between the first position and the second position mechanically couples the first attachment structure and second attachment structure by the magnetic element overcoming a magnetic attraction between the outer magnetic element and the inner magnetic element; and
moving the second attachment structure between the second position and the first position causes the inner magnetic element to assist in removing the outer magnetic element from the aperture.

2. The electronic device of claim 1, wherein in the first position the magnetic element does not exert an additional magnetic attraction on the outer magnetic element and in the second position the magnetic element exerts the additional magnetic attraction on the outer magnetic element to pull the outer magnetic element at least partially into the aperture.

3. The electronic device of claim 1, wherein the aperture comprises at least a first and second aperture that are positioned in opposing surfaces of the first attachment structure, the magnetic element comprises at least a first and second magnetic elements that are respectively positioned within the first and second apertures, and the outer magnetic element comprises at least a first and second magnetic element.

4. The electronic device of claim 1, wherein at least one of the magnetic element, the inner magnetic element, or the outer magnetic element comprises a hard magnet.

5. The electronic device of claim 1, wherein the inner magnetic element comprises a first hard magnet and a second hard magnet that are positioned such that a polarity of the first hard magnet is opposite a polarity of the second hard magnet.

6. The electronic device of claim 1, wherein the inner magnetic element comprises a soft magnet.

7. The electronic device of claim 6, wherein the soft magnet comprises a ferrous metal.

8. (canceled)

9. The electronic device of claim 1, wherein the electronic device housing further comprises a third attachment structure and the band further comprises a fourth attachment structure that is attachable to the third attachment structure.

10. The electronic device of claim 1, wherein a polarity of the magnetic element opposes a polarity of the outer magnetic element in the second position.

11. The electronic device of claim 10, wherein the polarity of the magnetic element is not opposite the polarity of the outer magnetic element in the first position.

12. The electronic device of claim 10, wherein the polarity of the magnetic element matches the polarity of the outer magnetic element in the first position.

13. The electronic device of claim 12, wherein the magnetic element repulses the outer magnetic element in the first position.

14. The electronic device of claim 1, wherein a polarity of the inner magnetic element opposes a polarity of the outer magnetic element in the first position and in the second position.

15. The electronic device of claim 1, wherein the first attachment structure and the second attachment structure are magnetically and mechanically coupled in the second position.

16. The electronic device of claim 1, wherein the outer magnetic element is at least a portion of a pin.

17. The electronic device of claim 1, further comprising a spacer positioned between at least one of the magnetic element and the outer magnetic element or the outer magnetic element and the inner magnetic element.

18. The electronic device of claim 17, wherein the spacer comprises a compliant material.

19. A band comprising:
an attachment structure including:
an inner magnetic element; and
an outer magnetic element;
wherein:
the attachment structure is moveable between a first position and a second position when inserted into an additional attachment structure of the electronic device;
moving the attachment structure between the first position and the second position mechanically couples the attachment structure and the additional attachment structure by a magnetic element of the additional attachment structure overcoming a magnetic attraction between the outer magnetic element and the inner magnetic element; and
moving the attachment structure between the second position and the first position causes the inner magnetic element to assist in removing the outer magnetic element from an aperture of the additional attachment structure.

20. An electronic device, comprising:
an attachment structure including:
an aperture; and
a magnetic element;
wherein:
an additional attachment structure of a band is moveable between a first position and a second position when inserted into the attachment structure;
moving the additional attachment structure between the first position and the second position mechanically couples the additional attachment structure and the attachment structure by the magnetic element overcoming a magnetic attraction between outer and inner magnetic elements of the additional attachment structure; and
moving the additional attachment structure between the second position and the first position causes the inner magnetic element to assist in removing the outer magnetic element from the aperture.

21. The band of claim 19, wherein the band comprises multiple band sections.

22. The band of claim 21, wherein a size of the band is adjustable.

23. The band of claim 19, wherein the first position is an assembled position and the second position is a disassemble position.

24. The band of claim 19, wherein movement between the first position and the second position is rotational movement.

25. The electronic device of claim 20, wherein the electronic device is a wearable electronic device.

26. The electronic device of claim 20, wherein the magnetic element is fixed in position.

27. The electronic device of claim 20, wherein the band is insertable into the attachment structure in a number of positions.

28. The electronic device of claim 20, further comprising a body that defines the aperture.
